(19) United States
(12) Patent Application Publication
(10) Pub. No.: US 2026/0073684 A1
(43) Pub. Date: Mar. 12, 2026

(54) APPARATUS AND METHODS FOR CLUSTERING AND MATCHING FEATURE DESCRIPTORS

(71) Applicant: QUALCOMM Incorporated, San Diego, CA (US)

(72) Inventors: Ronglu XIE, Chengdu (CN); Yao LIANG, Chengdu (CN); Zhixun XIA, Chengdu (CN)

(21) Appl. No.: 19/112,052

(22) PCT Filed: Dec. 9, 2022
(86) PCT No.: PCT/CN2022/137855

§ 371 Date: Mar. 14, 2025

(51) Int. Cl. G06V 20/20; G06V 10/46; G06V 10/74; G06V 10/762; G06V 10/94; G06V 20/56; G06V 20/59

(52) U.S. Cl. CPC G06V 20/20; G06V 10/46; G06V 10/761; G06V 10/763; G06V 10/95; G06V 20/588; G06V 20/597

(57) ABSTRACT

Methods, systems, and apparatuses are provided to cluster and match image feature descriptors for use in various systems. For example, a computing device receives a location from a remote device. The computing device applies a first clustering process to a plurality of descriptors associated with the location to determine a number of descriptor clusters. The computing device also applies a second clustering process to the number of descriptor clusters to determine a descriptor cluster center for each of the number of descriptor clusters. Further, the computing device generates descriptor cluster data characterizing a similarity between the plurality of descriptors and the descriptor cluster centers. The computing device then transmits the descriptor cluster data to the remote device. The remote device may match descriptors to the descriptor cluster centers based on the descriptor cluster data.

### BACKGROUND

### Field of the Disclosure

This disclosure relates generally to processes for determining feature descriptors and, more particularly, to clustering and matching image feature descriptors for use in driving systems.

### Description of Related Art

Various applications rely capturing images and determining features based on the captured images. For example, extended reality applications, such as augmented reality and mixed reality applications, may capture two-dimensional images, and may determine image descriptors characterizing image features. In some applications, vehicles, such as autonomous vehicles, may operate with vehicle monitoring systems that, among other things, enhance a driver's experience and safety. For example, vehicle monitoring systems may capture two-dimensional images of a vehicle's environment to determine the location of the vehicle, or may capture two-dimensional images of the driver to determine the driver's pose (e.g., a direction the driver is looking at). In such examples, image descriptors are determined from the captured two-dimensional images and compared to a database of features to determine the location or pose. In these and other examples, however, for various reasons, such as changing lighting conditions, seasonal changes, and object movement, the comparisons may be lacking and yield inaccurate results. As a result, the various applications employing such processes may suffer. For instance, in the example of vehicle monitoring systems, a driver's experience and safety within the cabin of the vehicle may be negatively affected. Moreover, as the database of features increases, the amount of memory required to store the additional features increases, as well as the processing power required to process the additional features, thereby increasing system cost and processing requirements.

### SUMMARY

According to one aspect, an apparatus comprises a non-transitory, machine-readable storage medium storing instructions, and at least one processor coupled to the non-transitory, machine-readable storage medium. The at least one processor is configured to execute the instructions to apply a first clustering process to a plurality of descriptors associated with a geographical location to determine a number of descriptor clusters. Further, the at least one processor is configured to execute the instructions to apply a second clustering process to the number of descriptor clusters to determine a descriptor cluster center for each of the number of descriptor clusters. The at least one processor is also configured to execute the instructions to generate descriptor cluster data characterizing a similarity between the plurality of descriptors and the descriptor cluster centers. The at least one processor is further configured to execute the instructions to store the descriptor cluster data in a data repository.

According to another aspect, a method by at least one processor includes applying a first clustering process to a plurality of descriptors associated with a geographical location to determine a number of descriptor clusters. Further, the method includes applying a second clustering process to the number of descriptor clusters to determine a descriptor cluster center for each of the number of descriptor clusters. The method also includes generating descriptor cluster data characterizing a similarity between the plurality of descriptors and the descriptor cluster centers. The method further includes storing the descriptor cluster data in a data repository.

According to another aspect, a non-transitory, machine-readable storage medium storing instructions that, when executed by at least one processor, causes the at least one processor to perform operations that include applying a first clustering process to a plurality of descriptors associated with a geographical location to determine a number of descriptor clusters. Further, the operations include applying a second clustering process to the number of descriptor clusters to determine a descriptor cluster center for each of the number of descriptor clusters. The operations also include generating descriptor cluster data characterizing a similarity between the plurality of descriptors and the descriptor cluster centers. The operations further include storing the descriptor cluster data in a data repository.

### BRIEF DESCRIPTION OF DRAWINGS

FIG. 1 is a block diagram of an exemplary vehicle monitoring system, according to some implementations;

FIG. 2 is a block diagram illustrating exemplary portions of the vehicle monitoring system of FIG. 1, according to some implementations;

FIG. 3 illustrates an iterative descriptor clustering process, according to some implementations;

FIG. 4 illustrates a messaging diagram, according to some implementations;

FIG. 5 is a flowchart of an exemplary process for clustering descriptors, according to some implementations; and

FIG. 6 is a flowchart of an exemplary process for performing operations based on matching image features to descriptors, according to some implementations.

### DETAILED DESCRIPTION

While the features, methods, devices, and systems described herein may be embodied in various forms, some exemplary and non-limiting embodiments are shown in the drawings, and are described below. Some of the components described in this disclosure are optional, and some implementations may include additional, different, or fewer components from those expressly described in this disclosure.

The embodiments described herein are directed to a computing environment that generates a database of clustered descriptors and corresponding cluster centers, and uses an iterative process to update the clustered descriptors and corresponding cluster centers based on performance criteria.

For example, in some implementations, a vehicle monitoring system, such as an advanced driver assistance (ADAS) system, may include a plurality of vehicles, such as autonomous vehicles, and a server-side computing system, such as a cloud computing system. The vehicle monitoring system may perform operations as described herein to detect objects and, for instance, perform localization operations to determine where a vehicle is located in the real world (e.g., with respect to the objects such as curbs, roads, other cars, etc.). Further, and based on the localization, the vehicle monitoring system may perform operations to determine a location of the vehicle within a map, such as a high-definition (HD) map. For example, the vehicles may use cameras, such as monochrome cameras, to capture images, such as two-dimensional (2D) images, of their environment. In some instances, the vehicles may include a pose device, such as a head mounted display (HMD) device, that captures images of a view of a driver of a vehicle. Further, the vehicle computing system may detect features (e.g., 2D observations) within the captured images, and may generate 2D image descriptors based on the detected features. The image descriptors may correspond to a particular geographic location (e.g., coordinate location, 3D reference point).

The vehicle monitoring system may employ a process, such as a simultaneous localization and mapping (SLAM) process, to generate three-dimensional (3D) image descriptors based on 2D image descriptors generated by the vehicles. Each 3D image descriptor may correspond to a geographic location (e.g., coordinate location, 3D reference point). For instance, each 3D image descriptor may correspond to a geographic location and be associated with multiple 2D features and their corresponding 2D image descriptors. For example, the vehicles may include a camera that captures images, such as 2D images, of respective environments. Each 2D image may include a plurality of 2D points (e.g., feature points), which may be referred to as an observation of a corresponding 3D point. For example, each 3D point may have multiple corresponding 2D points (e.g., based on images captured from the cameras of the vehicles). A 3D image descriptor corresponding to a 3D point may be generated based on the 2D points corresponding to the 3D point and their corresponding 2D image descriptors. The vehicles may send the 2D image descriptors to a server, such as a cloud-based server, and the server may generate a 3D image descriptor based on the received 2D image descriptors for a same 3D point.

Further, the vehicle monitoring system (e.g., the cloud computing system) may perform operations as described herein to cluster 3D image descriptors to generate 3D image descriptor clusters, and to determine a cluster center for each of the clusters. Further, the vehicle monitoring system may perform operations to generate descriptor cluster data characterizing a similarity (e.g., a probability) between the 3D image descriptors and the cluster center for each 3D image descriptor cluster.

As a vehicle moves through an environment, the vehicle may obtain the descriptor cluster data corresponding to the vehicle's geographical location. The vehicle may match a 2D feature detected in an image captured in the vehicle's geographical location to a cluster center identified in the descriptor cluster data. For instance, the vehicle may determine a distance (e.g., Euclidean distance) between the 2D feature and each cluster center, and match the 2D feature to the closest cluster center (the shortest computed distance). For instance, the determined cluster center may correspond to a corner of a building or some other object or object feature. In some examples, the vehicle may determine that the 2D feature is one of the building or other object or feature based on the matched features.

As such, the embodiments allow the vehicle monitoring system to identify objects, such as objects along a roadway, roadway markings, or other objects based on the 2D-3D feature matching. Further, and based on the matching, the vehicle monitoring system may perform additional operations, such as operations to determine alignment, localization, or driver pose, as part of the SLAM process, for instance.

In some instances, the vehicle monitoring system performs operations to update descriptor cluster data based on the matched 3D image descriptors. For example, each vehicle may send to the cloud computing system matching information that includes a number of matched reference points (e.g., matched 3D reference points), a ratio of matched reference points to a total number of reference points for a geographic location (e.g., the location corresponding to where the image was captured), and a number of descriptor matches (e.g., a ratio of matched 3D image descriptors to a total number of 3D image descriptors for a corresponding geographical location). The matching information may also include one or more of the matched 2D image descriptors, and the matched 3D image descriptors (i.e., the 3D image descriptors generated based on the captured image and matched to the 3D image feature of the descriptor cluster data) for a corresponding geographic location (e.g., 3D reference point).

The cloud computing system may perform operations to determine a matching performance of the geographic location based on the membership information, and may regenerate (e.g., update) the descriptor cluster data for the geographic location based on the matching performance. For example, the cloud computing system may determine, based on matching information received for a same geographical location from a plurality of vehicles, one or more of a total number of matched reference points, a ratio of matched reference points to a total number of reference points, a total number of descriptor matches, a total number of matched 2D image descriptors, and a total number of matched 3D image descriptors. Further, each 3D image descriptor and, in some instances, each cluster center associated with each 3D image descriptor, may be associated with a weighting value (e.g., coefficient value, importance coefficient). The cloud computing system may adjust the weighting values based on how often the 3D image descriptor is successfully matched (e.g., a vehicle successfully matches a 3D image descriptor corresponding to the geographic location to a 3D image descriptor of the received descriptor cluster data). For example, the weighting value of a 3D image descriptor, and the weighting value of the 3D image descriptor's corresponding cluster center, may be increased when the 3D image descriptor is successfully matched, and may be decreased when the 3D image descriptor is not successfully matched. The larger the weighting value of 3D image descriptors, the more clustering centers may be reserved, increasing the matching opportunities for the corresponding 3D point. The larger the weighting value of a cluster center, the more likely that the next iteration of clustering centers will be close to the cluster center, and the greater the possibility that the cluster center will be matched.

In some instances, the matching performance includes a statistical measure of a number of features successfully matched to the at least one descriptor cluster center. For instance, the matching performance may include a proportion of a number of vehicles that successfully matched a 3D image descriptor (e.g., over a time period) to a total number of vehicles that attempted to match the 3D image descriptor (e.g., total number of vehicles that moved through the same geographical location over the time period). In some instances, the matching performance for a cluster center includes a proportion of the number of times 3D image descriptors corresponding to the cluster center were successfully matched (e.g., over a period of time) to a total number of times the 3D image descriptors corresponding to the cluster center could have been matched (e.g., the total number of vehicles that moved through the same geographical location over the period of time multiplied by the number of 3D image descriptors for the cluster center).

The cloud computing system may then re-cluster the weighted 3D image descriptors, as well as, in some instances, any newly received 3D image descriptors (e.g., 3D image descriptors received for the first time), to re-generate the 3D image descriptor clusters, and re-determine the cluster centers for the re-generated 3D image descriptor clusters.

To re-determine the cluster centers, in some examples, the cloud computing system determines a matching performance, such as a statistical measure, of each geographic location. For instance, the cloud computing system may determine a proportion of a number of times a geographic location was successfully matched (e.g., over a time period) to a total number of times the geographic location could have been matched (e.g., over the time period). The cloud computing system may also determine a proportion of a number of times each cluster center associated with a geographic location was successfully matched (e.g., over a time period) to a total number of times each cluster center could have been matched (e.g., over the time period).

Based on the matching performance of each geographic location, the number of cluster centers may increase, or decrease. For instance, if the matching performance of a geographic location meets a predetermined criteria, the number of cluster centers may be increased (e.g., as the current cluster centers are stable). Otherwise, if the matching performance of the geographic location does not meet the predetermined criteria, the number of cluster centers may be decreased (e.g., to allow for more stable cluster centers). In some instances, the predetermined criteria indicates that the proportion of the number of times the geographic location was successfully matched is above a first threshold. In some instances, the predetermined criteria may, additionally or alternatively, identify that the proportion of the number of times each cluster center associated with the geographic location was successfully matched is above a second threshold, or that an average value of all the proportions for the clusters is above the second threshold.

Further, once the cluster centers have been established, the vehicle monitoring system may perform operations to re-generate the descriptor cluster data characterizing a similarity between the 3D image descriptors and the cluster center for each of the 3D image descriptor clusters. As such, the embodiments may provide a process to iteratively improve the descriptor cluster data for geographical locations.

Among other advantages, the embodiments reduce storage requirements, at least by not requiring the storage of all descriptors associated with a geographical location, and instead relying on descriptor cluster data that characterizes a similarity between descriptors and cluster centers. Moreover, the embodiments may require less processing resources (e.g., power and time) for matching descriptors than conventional techniques, and may allow for more accurate and efficient object detection by employing an iterative process that updates the descriptor cluster data based on newly obtained descriptors (e.g., feedback data). Persons of ordinary skill in the art having the disclosures herein may recognize these and other advantages of the embodiments as well.

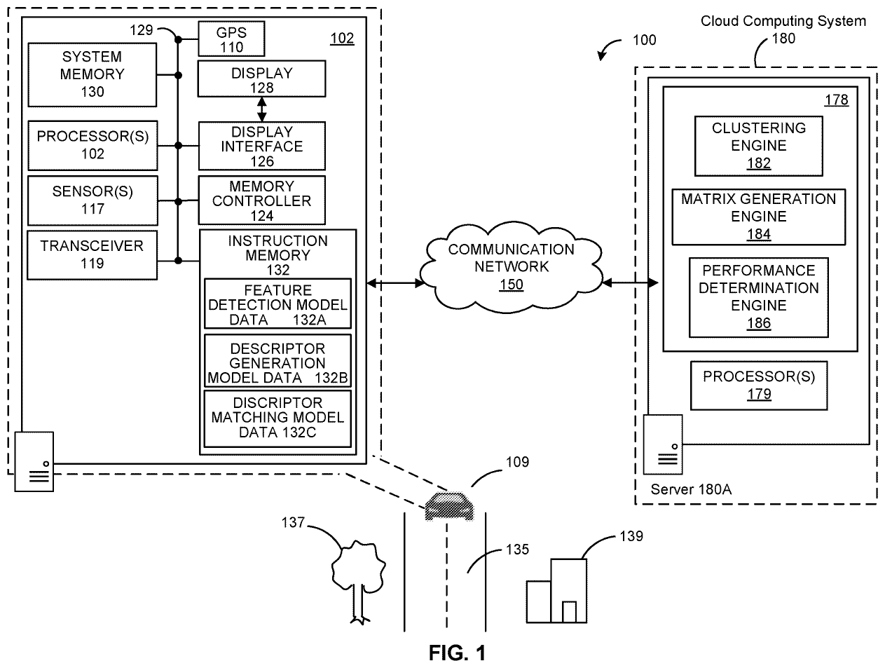

FIG. 1 is a block diagram of a vehicle monitoring system 100 that includes an advanced driver assistance (ADAS) system 102 for a vehicle 109 and a cloud computing system 180. Each of the ADAS system 102 and the cloud computing system 180 may be operatively connected to, and interconnected across, one or more communications networks, such as communication network 150. Examples of communication network 150 include, but are not limited to, a wireless local area network (LAN), e.g., a “Wi-Fi” network, a network utilizing radio-frequency (RF) communication protocols, a Near Field Communication (NFC) network, a wireless Metropolitan Area Network (MAN) connecting multiple wireless LANs, and a wide area network (WAN), e.g., the Internet.

It is to be appreciated that the specific configuration of components and communication interfaces between the different components shown in FIG. 1 are merely exemplary, and other configurations of the components, and/or other vehicle monitoring system with the same or different components, may be configured to implement the operations and processes of this disclosure.

ADAS system 102 may include one or more processors 112, one or more sensors 117, a transceiver 119, a Global Positioning System (GPS) device 110, a display interface 126 communicatively coupled to a display 128, a memory controller 124, a system memory 130, and instruction memory 132 configured to communicate with each other across bus 129. Bus 129 may include any of a variety of bus structures, such as a third-generation bus (e.g., a HyperTransport bus or an InfiniBand bus), a second-generation bus (e.g., an Advanced Graphics Port bus, a Peripheral Component Interconnect (PCI) Express bus, or an Advanced eXtensible Interface (AXI) bus), or another type of bus or device interconnect.

At least some of the functions of the ADAS system 102 may be implemented in one or more processors, one or more field-programmable gate arrays (FPGAs), one or more application-specific integrated circuits (ASICs), one or more state machines, digital circuitry, any other suitable circuitry, or any suitable hardware.

Processor(s) 112 may include any suitable processors, such as a central processing unit (CPU), a graphics processing unit (GPU), a microprocessor, or any other suitable processor. Processor(s) 112 may be configured to execute instructions to carry out one or more operations described herein. For instance, processor(s) 112 may read instructions from instruction memory 132, and execute the instructions to perform the operations.

Sensor 117 may include, for example, one or more optical sensors, such as cameras, configured to capture images of the vehicle's 109 environment. For instance, sensor 117 may be a camera configured to capture an image of the vehicle's 109 environment. For example, the camera may capture an image of a tree 137, a building 139, and/or a roadway 135 on which the vehicle 109 is travelling. In some examples, the camera may have a field-of-view in any direction with respect to vehicle 109, such as a forward-looking view, a backward-field-of-view, a sideways-field-of-view, an angled-filed of view, or any other suitable field-of-view. Sensor 117 may capture the image, and may store the image in a memory device (e.g., an internal memory device, system memory 130, etc.). Processor(2) 112 may obtain the captured image from the memory device or, in some examples, directly from sensor 117.

GPS device 110 may generate position data characterizing the vehicle's 109 position based on the GPS. For example, processor(s) 112 may receive data from GPS device 110 characterizing, for instance, a latitude and longitude of a location of GPS device 110. Further, transceiver 119 is configured to receive data from, and transmit data to, communication network 150. Additionally, display interface 126 is configured to output signals that cause graphical data to be displayed on a display 128 (e.g., dashboard display).

Memory controller 124 provides access to system memory 130 and to instruction memory 132. System memory 130 may store program modules and/or instructions and/or data that are accessible by processor(s) 112. For example, system memory 130 may store user applications (e.g., instructions for a camera application) and resulting images from sensor 117. System memory 130 may also store rendered images, such as three-dimensional (3D) images, rendered by processor(s) 112. System memory 130 may additionally store information for use by and/or generated by other components of ADAS system 102. For example, system memory 130 may act as a device memory for processor(s) 112. Examples of system memory 130 include one or more volatile or non-volatile memories or storage devices, such as RAM, SRAM, DRAM, EPROM, EEPROM, flash memory, a magnetic data media, a cloud-based storage medium, or an optical storage media.

Instruction memory 132 may store instructions that may be accessed (e.g., read) and executed by one or more processors 112. For example, instruction memory 132 may store instructions that, when executed by one or more processors 112, cause one or more of processors 112 to perform one or more of the operations described herein. For instance, instruction memory 132 can include instructions that, when executed by one or more of processors 112, cause one or more of processors 112 to apply one or more feature detection processes (e.g., machine learning processes) to a captured image to detect features, and to associate a detected feature to a descriptor cluster center identified within received descriptor cluster data.

For example, feature detection model data 132A can include instructions that, when executed by one or more of processors 112, cause one or more of processors 112 to apply a feature detection process to an image, such as one captured by a sensor 117, to determine 2D features. Descriptor generation model data 132B can include instructions that, when executed by one or more of processors 112, cause one or more of processors 112 to apply a descriptor generation process to the 2D features to generate a 3D image descriptor. Further, descriptor matching model data 132C can include instructions that, when executed by one or more of processors 112, cause one or more of processors 112 to match the 3D image descriptor to a descriptor cluster center, such as a descriptor cluster center within received descriptor cluster data, and identify an object or object feature based on the matched 3D image descriptor.

In some examples, ADAS system 102 includes a pose device, such as a head mounted display (HMD) device, that may measure a direction of view of the head of a driver of vehicle 109. For example, sensors 117 may include one or more of a gyroscope, an accelerometer, an inertial measurement unit, and any other type of sensor that may be configured to detect, measure, or generate sensor data associated with a position and/or orientation of a driver's head (e.g., a head pose). In some instances, the sensors 117 includes a camera positioned to capture an image of a view in a direction the driver's head is facing.

Cloud computing system 180 may include one or more servers 180A that are communicatively coupled to communication network 150. Server 180A may be any suitable computing device. For example, server 180A may include one or more processors 179 that can execute instructions stored within instruction memory 178. In this example, instruction memory 178 includes clustering engine 182, matrix generation engine 184, and performance determination engine 186. In some instances, server 180A executes a hypervisor that maintains virtual machines, where one or more of the clustering engine 182, matrix generation engine 184, and performance determination engine 186 are executed by one or more of the virtual machines.

Clustering engine 182 may include instructions that, when executed by one or more of processors 179, cause one or more of processors 179 to apply a first clustering process to a plurality of 3D image descriptors to determine a number of clusters. The instructions, when executed by one or more of processors 179, may also cause one or more of processors 179 to apply a second clustering process to the number of clusters to determine a cluster center for each of the number of clusters. Further, matrix generation engine 184 may include instructions that, when executed by one or more of processors 179, cause one or more of processors 179 to generate descriptor cluster data characterizing a similarity (e.g., probability) between the plurality of descriptors and the cluster centers. Performance determination engine 186 may include instructions that, when executed by one or more of processors 179, cause one or more of processors 179 to determine a matching performance of 3D descriptors for a geographic location (e.g., 3D reference point) based on matching information received from, for example, multiple vehicles 109.

As an example, vehicle 109 may be travelling down the roadway 135. A sensor 117 of the vehicle 109 may capture an image that includes, for instance, portions of the roadway 135, portions of the tree 137, and/or portions of the building 139. As described herein, processor 112 may generate 2D image features based on the captured image, and may generate a 3D descriptor based on the 2D image features. Further, processor 112 may obtain location data from GPS device 110, characterizing a location of the vehicle 109 (e.g., GPS coordinates). Further, processor 112 may receive, via transceiver 119 and from cloud computing system 180 over communication network 150, descriptor cluster data corresponding to the vehicle's 109 location. As described herein, the cloud computing system 180 may maintain descriptor cluster data, such as a descriptor cluster matrix, for each geographic location (e.g., 3D reference point), where the descriptor cluster data for each geographic location characterizes a similarity (e.g., a closeness, probability) between cluster descriptors and corresponding cluster centers.

Further, processor 112 may associate the 2D image features to a cluster center based on the descriptor cluster data. For example, the vehicle may match the 3D image descriptor generated from the 2D image features to a cluster center of the descriptor cluster data. Based on the matching, the vehicle may associate the 2D feature with the matched cluster center of the descriptor cluster data. For instance, the determined cluster center may correspond to a corner of the building 139, the tree 137, road markings of roadway 135, or some other object or object feature. Processor 112 may perform operations to identify the object (e.g., the building 139, the tree 137, the road markings of roadway 135) based on the matching. Further, and based on the matching, vehicle 109 may perform one or more operations. For example, vehicle 109 may perform a localization and/or an alignment. For instance, vehicle 109 may be an autonomous vehicle and, based on the object detection, may perform operations to stay within identified road markings of the roadway 135, or may perform operations to avoid an object.

Although the components and the operations of FIG. 1 are described with respect to vehicle monitoring system 100, in other examples, other systems and/or devices may include the same or similar components and implement some or all of the operations described herein. For example, in some examples, an extended reality (XR) system, such as augmented reality (AR) system, a virtual reality (VR) system, or a mixed reality (MR) system, may include a database of descriptor cluster data characterizing a similarity between descriptors and descriptor cluster centers as described herein. An XR device (e.g., such as a head mounted display (HMD) device) may capture an image (e.g., of a scene of the real-world), and may generate descriptors based on the captured image. Further, the XR device may obtain descriptor cluster data from the database. As described herein, the descriptor cluster data may include a plurality of values characterizing the similarity between the descriptors and the descriptor cluster centers. For instance, each of the plurality of values may characterize a similarity between one of the plurality of descriptors and one of the descriptor cluster centers. The XR device may then determine features within the captured image based on the generated descriptors and the descriptor cluster data. For instance, the XR device may match the generated descriptors to one of the descriptor cluster centers, and determine the features based on the matching, as described herein. The XR device may determine one or more objects based on the determined features, and may project on a display an image that includes the one or more objects (e.g., where the image is provided for viewing in extended reality space).

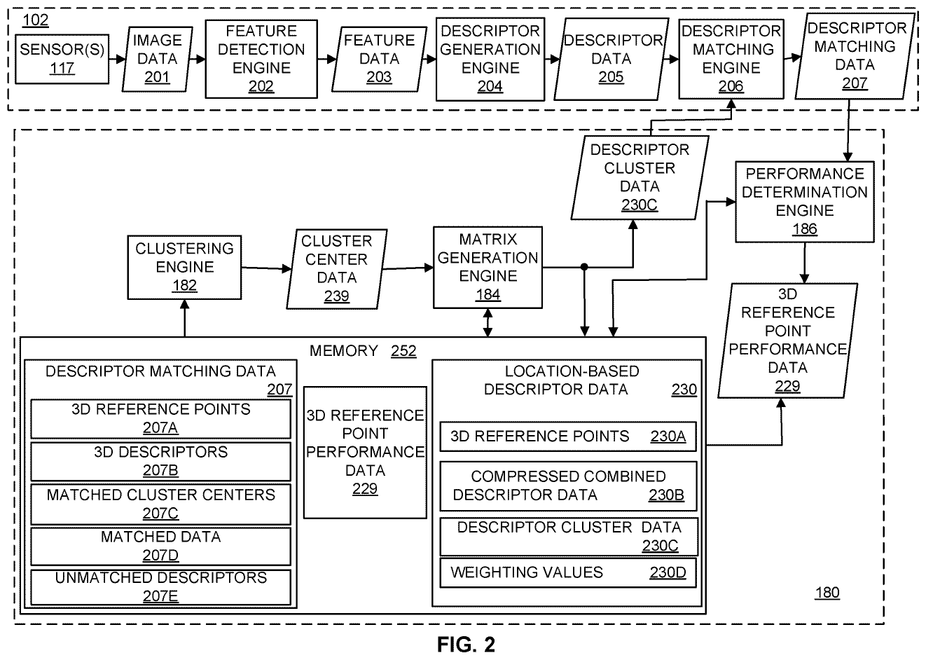

FIG. 2 is a diagram illustrating exemplary portions of the vehicle monitoring system 100 of FIG. 1 including ADAS system 102 and cloud computing system 180. In some instances, one or more of the operations carried out by the ADAS system 102 and the cloud computing system 180 are performed as part of a SLAM process. In this example, ADAS system 102 includes feature detection engine 202, descriptor generation engine 204, and descriptor matching engine 206. In some examples, each of feature detection engine 202, descriptor generation engine 204, and descriptor matching engine 206 may include instructions that, when executed by one or more processors 112, cause the one or more of processors 112 to perform corresponding operations. For example, feature detection engine 202 may include feature detection model data 132A, descriptor generation engine 204 may include descriptor generation model data 132B, and descriptor matching engine 206 may include descriptor matching model data 132C.

Further, cloud computing system 180 includes clustering engine 238, matrix generation engine 240, and performance determination engine 228. In some examples, one or more of feature detection engine 202, descriptor generation engine 204, descriptor matching engine 206, clustering engine 238, matrix generation engine 240, and performance determination engine 228 may be implemented in hardware, such as within one or more FPGAs, ASICs, digital circuitry, or any other suitable hardware or hardware or hardware and software combination.

Cloud computing system 180 also includes memory 252, which may be a ROM, RAM, hard drive, disk drive, cloud-based storage device, or any other suitable memory. Memory 252 stores, among other data, descriptor matching data 207, location-based descriptor data 230, and 3D reference point performance data 229. As described further below, descriptor matching data 207 may be received from vehicles 109 as they travel through various geographical locations.

Descriptor matching data 207 may include 3D reference points 207A identifying geographical locations (e.g., corresponding to a location of captured images), matched descriptors 207B characterizing descriptors that were successfully matched to a feature, matched cluster centers 207C characterizing descriptor cluster centers of descriptor cluster data 230C that were matched to a feature, unmatched descriptors 207E characterizing descriptors that were not matched and/or descriptors generated by the vehicle 109 that could not be matched to the descriptor cluster centers of descriptor cluster data 230C (e.g., new image descriptors), and matched data 207D characterizing descriptor matching information, such as a ratio of 3D descriptors of descriptor cluster data 230C that were successfully matched to a total number of 3D image descriptors of descriptor cluster data 230C for a corresponding geographical location.

Location-based descriptor data 230 may include 3D reference points 230A identifying one or more geographical locations, compressed combined descriptor data 230B characterizing one or more compressed combined descriptors for each corresponding 3D reference point 230A, descriptor cluster data 230C characterizing one or more membership matrices for each corresponding 3D reference point 230A. and weighting values 230D associated with compressed combined descriptor data 230B. As described herein, a 3D point descriptor may be generated based on multiple 2D observations and their respective individual descriptors for the corresponding 3D point. Moreover, the number of clustering centers may be determined based on the weighting values (e.g., importance coefficients), where clustered 3D point descriptors may be referred to as a compressed combined descriptor.

In this example, sensor(s) 117 captures an image, such as an image of vehicle's 109 environment, and generates image data 201 characterizing the captured image. Further, feature detection engine 202 receives the image data 201, and applies a feature detection process to the image data 201 to detect features, and generates image feature data 203 characterizing the detected features. For instance, the feature detection process may include a machine learning process trained to identify features within images. In some examples, the feature detection process includes establishing a deep learning model or a convolutional network to detect features from the image data 201. The feature data 203 may identify 2D image features within the image data 201, for instance.

Descriptor generation engine 204 receives the feature data 203, and applies a feature extraction process to the feature data 203 to generate descriptor data 205 characterizing image descriptors. For example, descriptor generation engine 204 may establish a Histogram of Oriented Gradients (HOG) feature extraction process, a speeded up robust features (SURF) feature extraction process, or any other suitable feature extraction process, and applies the established feature extraction process to the feature data 203 to generate the descriptor data 205. The descriptor data 205 may characterize 2D image descriptors, for instance.

As described herein, cloud computing system 180 may generate descriptor cluster data 230C characterizing a similarity between descriptors (e.g., 3D image descriptors) and descriptor cluster centers. For example, and with reference to cloud computing system 180, clustering engine 182 may obtain a plurality of 3D descriptors, such as matched descriptors 207B and/or unmatched descriptors 207E, from memory 252. Clustering engine 182 may apply a first clustering process to the plurality of 3D descriptors to determine a number of descriptor clusters for a corresponding geographic location, such as a 3D reference point 207A. As described herein, the plurality of descriptors may have been generated by a SLAM process based on 2D image features generated by one or more vehicles 109 traversing through the same geographic location (e.g., as identified by the corresponding 3D reference point 207A). In some instances, the first clustering process may include establishing an adaptive model that determines the number of descriptor clusters based on a coefficient value (e.g., importance coefficient) corresponding to each geographic location. As described herein, the coefficient value may be determined based on 3D reference point performance data 229 characterizing matching performances, such as a matching performance of the geographic location (e.g., a 3D reference point). For instance, 3D points may be associated with a corresponding weighting value (e.g., importance coefficient). The higher the weighting value of a 3D point, the more cluster centers the first clustering process may generate and associate with the 3D point. Further, the weighting value associated with each 3D point may be based on, for example, a number of observers of each 3D point, and a computed distance from the camera capturing a corresponding image to the 3D point (e.g., a distance from the camera capturing the image to the 3D point in 3D space). Clustering engine 182 may compute the distance based on a current location of the vehicle 109 and the 3D point, for example.

Further, clustering engine 182 may apply a second clustering process to the number of descriptor clusters to determine an initial descriptor cluster center for each of the descriptor clusters. For instance, clustering engine 182 may apply a k-means clustering process, such as a k-means++ process, to the number of descriptor clusters to generate the initial descriptor cluster centers. Based on the first clustering process and the second clustering process, clustering engine 182 generates cluster center data 239 characterizing the initial descriptor cluster centers.

Matrix generation engine 184 receives cluster center data 239 from clustering engine 182, and further obtains 3D descriptors, such as matched descriptors 207B and/or unmatched descriptors 207E, from memory 252. Based on the descriptor cluster centers identified in the cluster center data 239 and the plurality of 3D descriptors obtained from memory 252, matrix generation engine 185 generates compressed combined descriptor data 230B characterizing a compressed combined descriptor (e.g., subsequent descriptor cluster center) for the geographical location (e.g., for the corresponding 3D reference point 207A). Matrix generation engine 185 may store the compressed combined descriptor data 230B, and its corresponding 3D reference point 230A (which may correspond to the 3D reference point 207A from which the cluster center data 239 was generated from), within memory 252. In some instances, once the compressed combined descriptor data 230B is generated, matrix generation engine 185 deletes the corresponding plurality of 3D descriptors, such as matched descriptors 207B and/or unmatched descriptors 207E, from memory 252, thereby saving memory space. In some examples, after each clustering process, the centers and descriptor cluster matrix are retained, and the previous clustering centers and the 2D descriptors of the current iteration are deleted from memory.

Further, matrix generation engine 185 may generate descriptor cluster data 230C characterizing a similarity between the descriptor cluster centers of compressed combined descriptor data 230B and the plurality of 3D descriptors. For instance, descriptor cluster data 230C may include descriptor cluster data characterizing the descriptor cluster centers, and further include probability values characterizing a probability that each of the plurality of 3D descriptors belong to each of the descriptor cluster centers. The probability values may be based on a fuzzy c-means (FCM) algorithm, for example. In some examples, descriptor cluster data 230C includes a matrix of probability values, where each element of the matrix includes a probability value characterizing a probability that a 3D descriptor belongs to a descriptor cluster center. Matrix generation engine 185 may store the descriptor cluster data 230C within memory 252.

Further, as described herein, cloud computing system 180 may transmit the descriptor cluster data 230C to a vehicle 109, such as a vehicle 109 travelling through a geographical location (e.g., 3D reference point 230A) corresponding to the descriptor cluster data 230C. For instance, a vehicle 109 may determine its coarse position (e.g., via GPS), and may transmit its coarse position to the cloud computing system 180. In response, cloud computing system 180 may determine one or more 3D reference points 230A corresponding to the coarse position, and transmit to the vehicle 109 descriptor cluster data 230C corresponding to each of the one or more 3D reference points 230A.

As illustrated in FIG. 2, descriptor matching engine 206 receives descriptor data 205 from descriptor generation engine 204, which may characterize 2D image descriptors captured for a particular geographical location. Further, descriptor matching engine 206 may receive, from cloud computing system 180, descriptor cluster data 230C corresponding to the particular geographical location (as identified by 3D reference points 230A). Descriptor matching engine 206 performs any of the operations described herein to match the 2D image descriptors identified within descriptor data 205 to the descriptor cluster centers identified by the descriptor cluster data 230C based on the probability values of the descriptor cluster data 230C.

For example, descriptor matching engine 206 may compute a distance, such as a Euclidean distance, between each 2D image descriptor and each descriptor cluster center of the descriptor cluster data 230C. Further, descriptor matching engine 206 may determine an amount of similarity (e.g., degree of membership) between the computed distances for each 2D image descriptor and the descriptor cluster centers based on the probability values of the descriptor cluster data 230C. For example, descriptor matching engine 206 may multiply the computed distances between a 2D image descriptor and the descriptor cluster centers with the probability values corresponding to the same descriptor cluster centers to determine the amount of similarity between the computed distances for each 2D image descriptor and the descriptor cluster centers. Descriptor matching engine 206 may determine the most similar descriptor cluster center (e.g., the closest descriptor cluster center) to each 2D image descriptor based on the amounts of similarity, thereby matching each 2D image descriptor to the closest descriptor cluster center. For instance, a vehicle, such as vehicle 109, may match cluster centers of a 3D reference point with 2D points'individual descriptors (e.g., those from the camera frame of a vehicle moving and trying to localize itself) based on the descriptor cluster data 230C to get a more reasonable matching result. When computing the distance of an individual descriptor (seen in a camera frame) to the clusters of the compressed combined descriptor of the 3D reference point, descriptor matching engine 206 may compute the distance to each cluster center respectively and then may multiply by the degree of membership. Once the distance to each cluster center is computed, descriptor matching engine 206 selects the cluster center with the minimum distance as the final result.

Based on the matching, vehicle 109 may identify an object within the captured image. For example, as part of a SLAM process, vehicle 109 (e.g., using processors 112) may, based on the identified object, perform alignment operations (e.g., obstacle avoidance procedure), path planning operations, and/or a localization operations. For instance, vehicle 109 may perform localization operations to determine where a vehicle is located in the real world (e.g., with respect to the object) and, based on the localization, determine a location of the vehicle within a map, such as a high-definition (HD) map (e.g., mapping operations).

Further, descriptor matching engine 206 may generate descriptor matching data 207 characterizing the matched 2D image descriptors. For example, descriptor matching data 207 may identify, in some instances, one or more of the matched 2D image descriptors 207B, the matched cluster centers 207C, and the corresponding 3D reference point 207A. Descriptor matching data 207 may also include matched data 207D, which may characterize one or more of a number of 3D reference points 207A matched. Descriptor matching data 207 may also include unmatched descriptors 207E, which can include unmatched 2D image descriptors (e.g., new image descriptors). Vehicle 109 may transmit the descriptor matching data 207 to cloud computing system 180.

Cloud computing system 180 may receive descriptor matching data 207 from one or more vehicles for one or more locations, and may adjust (e.g., update) the corresponding location-based descriptor data 230 based on the received descriptor matching data 207. For example, performance determination engine 186 may receive descriptor matching data 207, which as described herein may include one or more of 3D reference points 207A, matched descriptors 207B, matched cluster centers 207C, and matched data 207D, and may store the descriptor matching data 207 within memory 252.

Further, performance determination engine 186 may determine a matching performance of each 3D reference point 230A based on the descriptor matching data 207, and may regenerate (e.g., update) the descriptor cluster data 230C within memory 252 for the 3D reference point 230A based on the matching performance. For instance, each compressed combined descriptor (e.g., as identified by compressed combined descriptor data 230B) may be associated with a weighting value 230D (e.g., coefficient value). Performance determination engine 186 may adjust the weighting values based on how often the each compressed combined descriptor is successfully matched (e.g., a vehicle successfully matches a 2D image descriptor to a compressed combined descriptor of the received descriptor cluster data 230C). For example, the weighting value of a compressed combined descriptor may be increased when the compressed combined descriptor is successfully matched, and may be decreased when the compressed combined descriptor is not successfully matched, as indicated by descriptor matching data 207.

In some instances, performance determination engine 186 determines matching performance of compressed combined descriptors. For example, performance determination engine 186 may determine a proportion of a number of vehicles that successfully matched a compressed combined descriptor (e.g., over a time period) to a total number of vehicles that attempted to match the compressed combined descriptor (e.g., total number of vehicles that moved through the same geographical location over the time period). In some instances, performance determination engine 186 determines for a compressed combined descriptor a proportion of the number of times 3D image descriptors corresponding to the compressed combined descriptor were successfully matched (e.g., over a period of time) to a total number of times the 3D image descriptors corresponding to the compressed combined descriptor could have been matched (e.g., the total number of vehicles that moved through the same geographical location over the period of time multiplied by the number of 3D image descriptors for the descriptor cluster center).

In some examples, performance determination engine 186 determines matching performance of 3D reference points 230A. For example, performance determination engine 186 may determine a proportion of a number of vehicles that successfully matched a 3D reference point 230A (e.g., over a time period) to a total number of vehicles that attempted to match the 3D reference point 230A (e.g., total number of vehicles that moved through the same geographical location over the time period). In some examples, performance determination engine 186 determines the matching performance of a 3D reference point 230A based on a determined number of observers (e.g., vehicles 109) of each 3D reference point 230A, and the computed distance from a camera of each 3D reference point 230A, as described herein.

Based on the matching performance of each geographic location, performance determination engine 186 may determine whether the matching performance of a geographic location meets a predetermined criteria. If the predetermined criteria is met, the number of cluster centers may be increased (e.g., as the current cluster centers are stable). Otherwise, if the matching performance of the geographic location does not meet the predetermined criteria, the number of cluster centers may be decreased (e.g., to allow for more stable cluster centers). In some instances, the predetermined criteria includes a proportion of the number of times the 3D reference point 230A was successfully matched, and whether the proportion is above a first threshold. In some instances, the predetermined criteria may, additionally or alternatively, include a proportion of the number of times each descriptor cluster center associated with the 3D reference point 230A was successfully matched, and whether the proportion is above a second threshold. In some examples, the predetermined criteria may, additionally or alternatively, indicate whether an average value of the proportions for all descriptor cluster centers corresponding to a 3D reference point 230A is above a third threshold.

Further, performance determination engine 186 may generate 3D reference point performance data 229 characterizing one or more of these matching performance determinations, and stores the 3D reference point performance data 229 within memory 252.

In some instances, clustering engine 182 clusters (e.g., re-clusters) the matched descriptors 207B received within descriptor matching data 207 with the compressed combined descriptors identified within the compressed combined descriptor data 230B to generate updated cluster center data 239 as described herein. For example, clustering engine 182 may apply the first clustering process to the matched descriptors 207B and the compressed combined descriptors to determine an updated number of descriptor clusters for a corresponding geographic location, such as a 3D reference point 207A.

In some examples, the first clustering process includes determining the updated number of descriptor clusters based, at least in part, on the 3D reference point performance data 229. For example, based on the matching performance of each 3D reference point 207A as identified by corresponding 3D reference point performance data 229 (e.g., a proportion of the number of vehicles that were able to match the 3D reference point 207A, a proportion of the number of times the 3D reference point 207A was successfully matched, a proportion of the number of times each descriptor cluster centers associated with the 3D reference point 207A was successfully matched, an average value of all the proportions for the clusters, etc.), the number of descriptor cluster centers may increase, or decrease. For instance, if the matching performance of a 3D reference point 207A meets a predetermined criteria (e.g., at or above corresponding thresholds), the number of cluster centers may be increased (e.g., as the current cluster centers are stable). Otherwise, if the matching performance of the 3D reference point 207A does not meet the predetermined criteria (e.g., below the corresponding thresholds), the number of cluster centers may be decreased (e.g., to allow for more stable cluster centers).

Further, clustering engine 182 may apply a second clustering process to the updated number of descriptor clusters to determine updated descriptor cluster centers for each of the updated number of descriptor clusters. Based on the first clustering process and the second clustering process, clustering engine 182 generates updated cluster center data 239 characterizing the updated descriptor cluster centers.

Further, matrix generation engine 184 may receive the updated cluster center data 239 characterizing updated descriptor cluster centers, and may generate updated compressed combined descriptor data 230B and updated descriptor cluster data 230C based on the updated cluster center data 239. Matrix generation engine 184 may store the updated compressed combined descriptor data 230B and updated descriptor cluster data 230C within memory 252 (e.g., by overwriting the corresponding previous compressed combined descriptor data 230B and descriptor cluster data 230C).

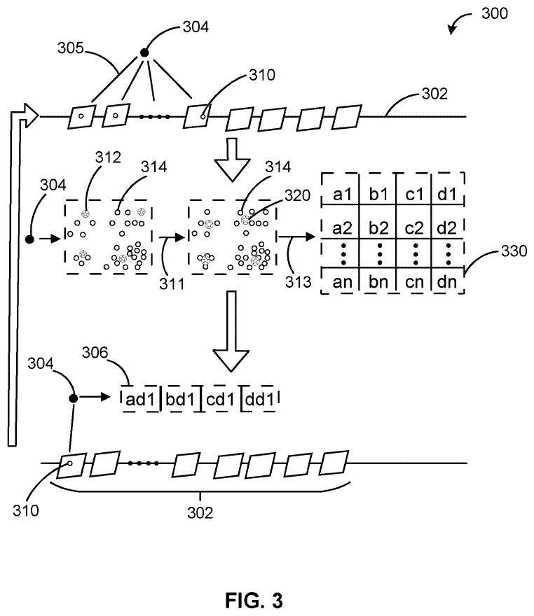

FIG. 3 illustrates an iterative descriptor clustering process 300 that generates descriptor cluster data, such as descriptor cluster matrix 330, based on clustering 3D reference points 304 generated from images of an image sequence 302. As illustrated, 2D image descriptors 310 are determined based images of an image sequence 302. For instance, and as described herein, a 3D reference point 304 may be associated with various 2D reference points of an image sequence 302. The image sequence 302 may include images captured, for example, by a vehicle 109. Further, each 3D reference point 304 may be associated with a plurality of 3D image descriptors 314. At a cloud computing system, such as cloud computing system 180, a first clustering process 311, such as a k-means++ process, may be applied to the plurality of 3D image descriptors 314 as well as any current descriptor cluster centers 312 (e.g., as determined by a previous iteration of the iterative descriptor clustering process 300) to determine a number of initial descriptor cluster centers 320 for the corresponding 3D reference point 304.

Further, at the cloud computing system 180, a second clustering process 313, such as a fuzzy c-means clustering process, is applied to the initial descriptor cluster centers 320 and the plurality of 3D image descriptors 314 to generate descriptor cluster matrix 330 characterizing a compressed combined descriptor for each of a plurality of final cluster centers. For instance, each column of the descriptor cluster matrix 330 represents a final cluster center (e.g., as represented by “a,”, “b”, “c,” and “d,”), and each row of the descriptor cluster matrix 330 represents a 3D point descriptor 314 (e.g., as represented by “1” through “n”). Further, the descriptor cluster matrix 330 includes a probability value for each final cluster center and 3D point descriptor 314 pair characterizing a probability that each 3D point descriptor 314 belongs to each final cluster center. For instance, element “a1” includes a probability value characterizing a probability that 3D point descriptor “1” belongs to final cluster center “a”, while element “dn” includes a probability value characterizing a probability that 3D point descriptor “n” belongs to final cluster center “d.”

The cloud computing system 180 may transmit the descriptor cluster matrix 330 to a vehicle, such as vehicle 109, travelling through a location corresponding to the 3D reference point 304.

The vehicle 109 may receive the descriptor cluster matrix 330, and may perform operations (e.g., fuzzy 3D-2D matching operations) to match a 2D image descriptor of an image of the image sequence 302 to a descriptor cluster center (e.g., “a,” “b,” “c,” or “d”) of the descriptor cluster matrix 330. For instance, and as described herein, the vehicle 109 may apply a feature detection process to the images of the image sequence 302 to detect 2D image features. Further, the vehicle 109 may apply a descriptor generation process to the detected 2D image features to generate 2D image descriptors 310.

Vehicle 109 may then perform any of the operations described herein to determine a distance, such as a Euclidean distance, between each 2D image descriptor 310 and each descriptor cluster center, and may match the 2D image descriptor 310 to the closest descriptor cluster center (the shortest computed distance.

In some examples, vehicle 109 may generate a 2D descriptor matrix characterizing the distances from one or more 2D image descriptors 310 to each descriptor cluster center. Further, vehicle 109 may multiply the 2D descriptor matrix with the probability values of a transpose of the descriptor cluster matrix 330 to determine distance values, and may also determine a minimum distance value of the distance values. Vehicle 109 may match each 2D image descriptor 310 to the descriptor cluster center corresponding to the minimum distance value.

As described herein, vehicle 109 may perform operations, such as SLAM operations (e.g., alignment, localization, etc.), based on the descriptor cluster center matched to the 2D image descriptor 310. For example, the vehicle 109 may perform the SLAM operations in response to the matching. In some examples, vehicle 109 may determine an object (e.g., corner of a building 139, a tree 137, road markings on a roadway 135, etc.) based on the matching, and may perform the SLAM operations based on the determined object.

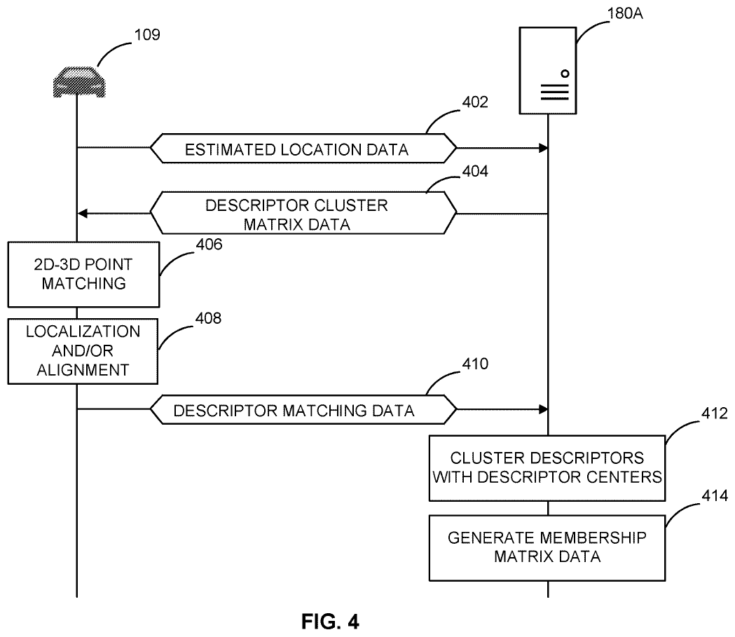

FIG. 4 illustrates a messaging diagram 400 between a vehicle 109 and a server 180A of cloud computing system 180. Vehicle 109 may be travelling along a roadway, such as roadway 135, and may determine an initial location. For example, vehicle 109 may determine its location based on GPS (e.g., using GPS device 110). Vehicle 109 may generate estimated location data 402 characterizing the initial location, and may transmit estimated location data 402 to server 180A of cloud computing system 180.

Further, and based on the estimated location data 402, server 180A may perform any of the processes described herein to generate descriptor cluster matrix data characterizing a descriptor cluster matrix, such as descriptor cluster matrix 330, for the location. As described herein, the descriptor cluster matrix may identify and characterize one or more probability values characterizing a probability that each of a plurality of 3D descriptors belong to each of a plurality of descriptor cluster centers. Vehicle 109 may receive the descriptor cluster matrix data 404, and may perform 2D-3D point matching operations to match 2D features to the plurality of descriptor cluster centers. For example, vehicle 109 may capture one or more images a the location identified by the estimated location data 402, and may determine 2D image features based on the captured images, as described herein. Further, vehicle 108 may perform any of the operations described herein to match each 2D image feature to one of the plurality of descriptor cluster centers of the descriptor cluster matrix data 404 based on the probability values of the descriptor cluster matrix data 404, as described herein.

Further, and based on the 2D-3D point matching 406, vehicle 109 may perform one or more operations, such as SLAM operations. For example, vehicle 109 may identify one or more objects based on the 2D-3D point matching 406. Based on the identified objects, vehicle 109 may perform a SLAM localization and/or a SLAM alignment. Vehicle 109, in some examples, may transmit data to server 180A, such as data identifying the type of object, and any SLAM operations taken in light of the identified object, such as the localization and/or alignment.

Vehicle 109 may also generate descriptor matching data 410 characterizing the matching of 2D image features to one of the plurality of descriptor cluster centers of the descriptor cluster matrix data 404. For instance, and as described herein, the descriptor matching data 410 may identify 3D reference points 207A, matched descriptors 207B, matched cluster centers 207C, and matched data 207D. Vehicle 109 may transmit the descriptor matching data 410 to server 180A.

Server 180A may receive the descriptor matching data 410, and may perform operations to cluster 412 the descriptor cluster centers of the descriptor cluster matrix data with matched image descriptors identified within the descriptor matching data 410. For instance, server 180A may apply a first clustering process, such as a k-means++ process, to the descriptor cluster centers and the image descriptors to determine a number of updated descriptor cluster centers for a corresponding 3D reference point. In some instances, the first clustering process includes weighting the descriptor cluster centers based on matched data 207D, as described herein. Further, server 180A may apply a second clustering process, such as a fuzzy c-means clustering process, to the number of updated descriptor cluster centers and the image descriptors to generate a compressed combined descriptor for each of a plurality of final cluster centers. For instance, server 180A may replace, within memory 252, any individual image descriptors of the 3D reference point with the compressed combined descriptor.

Moreover, and based on the compressed combined descriptors, vehicle 109 may perform any of the operations herein to generate descriptor cluster matrix data 414 characterizing a descriptor cluster matrix, such as descriptor cluster matrix 330. The descriptor cluster matrix may include probability values characterizing a probability that each image descriptor belongs to each of the plurality of final cluster centers.

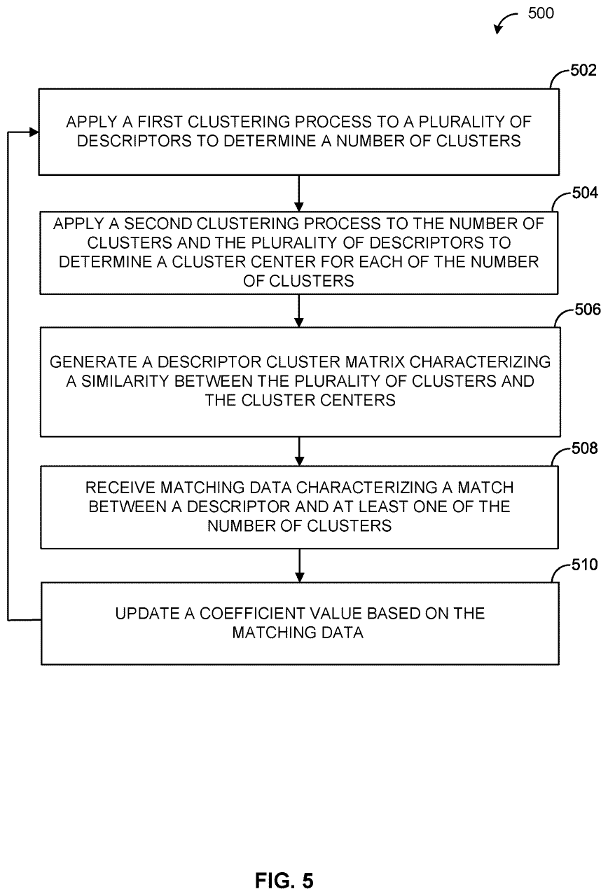

FIG. 5 is a flowchart of an exemplary process 500 for clustering descriptors, such as image descriptors. For example, one or more computing devices, such as server 180A, may perform one or more operations of exemplary process 500, as described below in reference to FIG. 5.

Referring to FIG. 5, at block 502 server 180A may apply a first clustering process to a plurality of descriptors to determine a number of clusters. For instance, as described herein, server 180A may apply a k-means clustering process, such as a k-means++ process, to the plurality of descriptors to determine the number of clusters. For example, server 180A may determine the number of cluster centers based on corresponding coefficient values (e.g., importance coefficients), and may apply a k-means++ model to generate the initial cluster centers according to determined number of cluster centers (i.e., execute the k-means++ model, and apply the executed k-means++ model to the plurality of descriptors to generate the number of cluster centers).

Further, at block 504, server 180A applies a second clustering process to the number of clusters and the plurality of descriptors to determine a compressed combined descriptor for each of the number of clusters. For instance, and as described herein, server 180A applies fuzzy c-means clustering process to the number of clusters and the plurality of descriptors to determine compressed combined descriptor data 230B. At step 506, server 180A generates a descriptor cluster matrix based on the compressed combined descriptors and the plurality of descriptors. The descriptor cluster matrix characterizes a probability that each of the plurality of descriptors belong to each of the compressed combined descriptors. For instance, server 180A may generate descriptor cluster matrix 330 characterizing that any of descriptors 1-n belong to any of descriptor clusters “a,” “b,” “c,” and “d.”

Proceeding to block 508, server 180A receives matching data characterizing a match between a descriptor and at least one of the number of clusters. For example, server 180A may receive, from at least one vehicle 109, descriptor matching data 207, which may include one or more of 3D reference points 207A identifying geographical locations (e.g., corresponding to a location of captured images), matched descriptors 207B characterizing descriptors of descriptor cluster data 230C that were successfully matched, matched cluster centers 207C characterizing descriptor cluster centers that were matched, and matched data 207D characterizing descriptor matching information. For instance, vehicle 109 may generate descriptor matching data 207 based on matching 2D image features to the descriptor cluster centers of the descriptor cluster matrix 330, and may transmit to server 180A descriptor matching data 207 based on the matching.

At block 510, server 180A updates a coefficient value (e.g., weighting value) based on the matching data. For example, the server 180A may increase a coefficient value of a descriptor cluster center when the matching data indicates the descriptor cluster center was successfully matched for a 3D reference point more than a threshold percentage (e.g., over a period of time, such as a month), and may decrease the coefficient value of the descriptor cluster center when the matching data indicates the descriptor center was not successfully matched for the 3D reference point at least the threshold percentage.

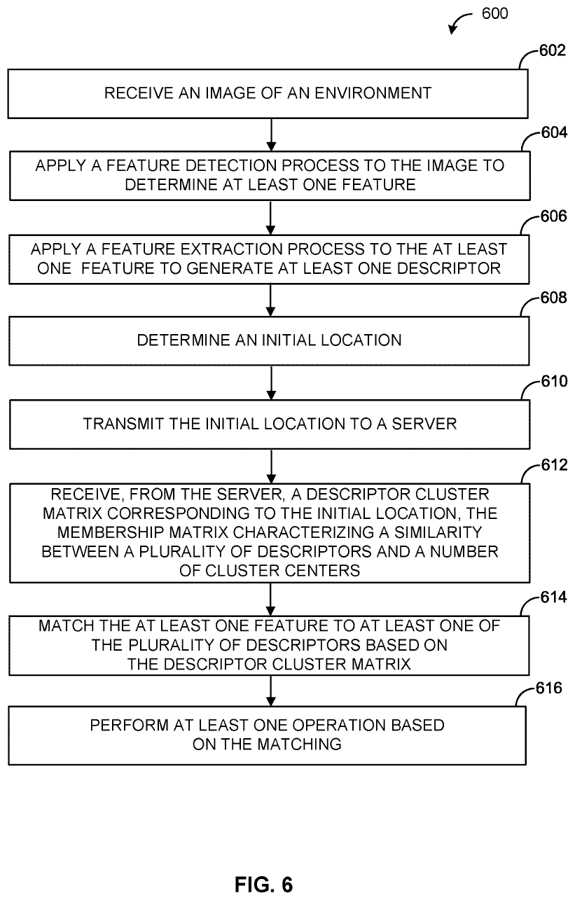

FIG. 6 is a flowchart of an exemplary process 600 for performing operations based on matching image features to descriptors. For example, one or more computing devices, such as one or more processors 112, may perform one or more operations of exemplary process 600, as described below in reference to FIG. 6. In some examples, an XR device, such as an AR device, a VR device, or an MR device, may perform one or more of the operations of exemplary process 600.

Beginning at block 602, processor 112 receives an image of an environment. For instance, sensor 117 may be a camera, and the camera may capture an image of the vehicle's 109 environment. Processor 112 may receive the captured image from the camera. At block 604, processor 112 applies a feature detection process to the image to determine at least one feature. For example, processor 112 may apply a trained machine learning process to the image to determine the at least one feature. Further, at block 606, processor 112 applies a feature extraction process to the at least one feature to generate at least one descriptor. For example, and as described herein, processor 112 may apply a HOG feature extraction process to the at least one feature to generate the at least one descriptor.

Proceeding to block 608, processor 112 determines an initial location. For example, the processor 112 may obtain, from GPS device 110, GPS data characterizing a location of vehicle 109. At block 610, processor 112 transmits the initial location to a server, such as server 180A of the cloud computing system 180.

Further, at block 612, processor 112 receives, from the server, a descriptor cluster matrix corresponding to the initial location. The descriptor cluster matrix characterizes a similarity between a plurality of descriptors and a number of cluster centers. For example, and as described herein, server 180A may apply one or more clustering processes to a plurality of descriptors associated with the initial location to generate a descriptor cluster matrix, such as descriptor cluster matrix 330, that includes probability values, where each probability value is a probability that a descriptor belongs to a compressed combined descriptor.

Proceeding to block 614, processor 112 matches the at least one feature to at least one of the plurality of descriptors based on the descriptor cluster matrix. For example, processor 112 may compute a distance, such as a Euclidean distance, between each of the plurality of descriptors and each compressed combined descriptor of the descriptor cluster matrix. Further, processor 112 may determine an amount of similarity (e.g., degree of membership) between each of the descriptors and each compressed combined descriptor based on the computed distances and corresponding probability values of the descriptor cluster matrix. Processor 112 may then match the at least one feature to the most similar compressed combined descriptor (e.g., as indicated by the highest amount of similarity of the computed amounts of similarity).

At block 616, processor 112 may perform at least one operation based on the matching. For example, the most similar compressed combined descriptor may correspond to a building 139, a tree 137, or markings of a roadway 135. Based on the matching, processor 112 may determine that the at least one feature is a feature of the building 139, tree 137, or markings of the roadway 135, and may, based on the identified object, perform alignment operations (e.g., obstacle avoidance procedure), path planning operations, and/or a localization operations, among various examples.

Implementation examples are further described in the following numbered clauses:

1. An apparatus comprising:
a non-transitory, machine-readable storage medium storing instructions; and
at least one processor coupled to the non-transitory, machine-readable storage medium, the at least one processor being configured to execute the instructions to:
   apply a first clustering process to a plurality of descriptors associated with a geographical location to determine a number of descriptor clusters;
   apply a second clustering process to the number of descriptor clusters to determine a descriptor cluster center for each of the number of descriptor clusters;
   generate descriptor cluster data characterizing a similarity between the plurality of descriptors and the descriptor cluster centers; and
   store the descriptor cluster data in a data repository.

2. The apparatus of clause 1, wherein the at least one processor is further configured to execute the instructions to generate the descriptor cluster data to include a plurality of values characterizing the similarity between the plurality of descriptors and the descriptor cluster centers, wherein each of the plurality of values characterizes the similarity between one of the plurality of descriptors and one of the descriptor cluster centers.

3. The apparatus of clause 2, wherein each of the plurality of values identifies a probability that one of the plurality of descriptors belongs to one of the descriptor cluster centers.

4. The apparatus of any of clauses 1-3, wherein the at least one processor is further configured to execute the instructions to:
receive, from a remote device, location data characterizing the geographic location; and
in response to receiving the location data, transmit the descriptor cluster data to the remote device.

5. The apparatus of clause 4, wherein the at least one processor is further configured to execute the instructions to:
receive descriptor matching data from the remote device, the descriptor matching data characterizing a matching result of the descriptor cluster data; and
adjust the descriptor cluster data in the data repository based on the descriptor matching data.

6. The apparatus of clause 5, wherein the descriptor matching data comprises a number of descriptor matches for at least one of the descriptor cluster centers, wherein at least one processor is configured to execute the instructions to:
determine a matching performance of the at least one of the descriptor cluster centers based on the number of descriptor matches; and
adjust the descriptor cluster data based on the matching performance.

7. The apparatus of any of clauses 5-6, wherein the at least one processor is further configured to execute the instructions to:
weight the descriptor cluster centers based on the descriptor matching data;
apply the first clustering process to the plurality of descriptors and the weighted descriptor cluster centers to determine a second number of descriptor clusters;
apply the second clustering process to the second number of descriptor clusters to determine a second descriptor cluster center for each of the second number of descriptor clusters; and
adjust the descriptor cluster data to characterize a similarity between the plurality of descriptors and the second number of descriptor cluster centers.

8. The apparatus of any of clauses 1-7, wherein the at least one processor is configured to execute the instructions to:
receive from a plurality of remote devices descriptor matching data for the geographic location, the descriptor matching data characterizing a matching result of at least one descriptor cluster center to a number of features, and a statistical measure based on a number of features successfully matched to the at least one descriptor cluster center;
determine a matching performance for the geographic location based on the matching result of the at least one descriptor cluster center to the number of features, and the statistical measure; and
adjust the descriptor cluster data based on the matching performance.

9. The apparatus of clause 8, wherein the at least one processor is configured to execute the instructions to:
adjust a weight of the at least one descriptor cluster center based on the matching performance;
weight the at least one descriptor cluster center based on the weight;
apply the first clustering process to the plurality of descriptors and the descriptor cluster centers to determine a second number of descriptor clusters, the descriptor cluster centers comprising the weighted at least one descriptor cluster center;
apply the second clustering process to the second number of descriptor clusters to determine a second descriptor cluster center for each of the second number of descriptor clusters; and
adjust the descriptor cluster data to characterize a similarity between the plurality of descriptors and the second number of descriptor cluster centers.

10. The apparatus of any of clauses 1-9, wherein the at least one processor is configured to execute the instructions to establish the first clustering process as a k-means++ clustering process.

11. The apparatus of any of clauses 1-10, wherein the at least one processor is configured to execute the instructions to establish the second clustering process as a fuzzy c-means clustering process.

12. A method by at least one processor, the method comprising:
applying a first clustering process to a plurality of descriptors associated with a geographical location to determine a number of descriptor clusters;
applying a second clustering process to the number of descriptor clusters to determine a descriptor cluster center for each of the number of descriptor clusters;
generating descriptor cluster data characterizing a similarity between the plurality of descriptors and the descriptor cluster centers; and
storing the descriptor cluster data in a data repository.

13. The method of clause 12, comprising generating the descriptor cluster data to include a plurality of values characterizing the similarity between the plurality of descriptors and the descriptor cluster centers, wherein each of the plurality of values characterizes the similarity between one of the plurality of descriptors and one of the descriptor cluster centers.

14. The method of clause 13, wherein each of the plurality of values identifies a probability that one of the plurality of descriptors belongs to one of the descriptor cluster centers.

15. The method of any of clauses 12-14, comprising:
receiving, from a remote device, location data characterizing the geographic location; and
in response to receiving the location data, transmitting the descriptor cluster data to the remote device.

16. The method of clause 15, comprising:
receiving descriptor matching data from the remote device, the descriptor matching data characterizing a matching result of the descriptor cluster data; and
adjusting the descriptor cluster data in the data repository based on the descriptor matching data.

17. The method of clause 16, wherein the descriptor matching data comprises a number of descriptor matches for at least one of the descriptor cluster centers, the method comprising:
determining a matching performance of the at least one of the descriptor cluster centers based on the number of descriptor matches; and
adjusting the descriptor cluster data based on the matching performance.

18. The method of any of clauses 16-17, comprising:
weighting the descriptor cluster centers based on the descriptor matching data;
applying the first clustering process to the plurality of descriptors and the weighted descriptor cluster centers to determine a second number of descriptor clusters;
applying the second clustering process to the second number of descriptor clusters to determine a second descriptor cluster center for each of the second number of descriptor clusters; and
adjusting the descriptor cluster data to characterize a similarity between the plurality of descriptors and the second number of descriptor cluster centers.

19. The method of any of clauses 12-18, comprising:
receiving from a plurality of remote devices descriptor matching data for the geographic location, the descriptor matching data characterizing a matching result of at least one descriptor cluster center to a number of features, and a statistical measure of a number of features successfully matched to the at least one descriptor cluster center;
determining a matching performance for the geographic location based on the matching result of the at least one descriptor cluster center to the number of features, and the statistical measure; and
adjusting the descriptor cluster data based on the matching performance.

20. The method of clause 19, comprising:
adjusting a weight of the at least one descriptor cluster center based on the matching performance;
weighting the at least one descriptor cluster center based on the weight;
applying the first clustering process to the plurality of descriptors and the descriptor cluster centers to determine a second number of descriptor clusters, the descriptor cluster centers comprising the weighted at least one descriptor cluster center;
applying the second clustering process to the second number of descriptor clusters to determine a second descriptor cluster center for each of the second number of descriptor clusters; and
adjusting the descriptor cluster data to characterize a similarity between the plurality of descriptors and the second number of descriptor cluster centers.

21. The method of any of clauses 12-20, comprising establishing the first clustering process as a k-means++ clustering process.

22. The method of any of clauses 12-21, comprising establishing the second clustering process as a fuzzy c-means clustering process.

23. A non-transitory, machine-readable storage medium storing instructions that, when executed by at least one processor, causes the at least one processor to perform operations that include:
applying a first clustering process to a plurality of descriptors associated with a geographical location to determine a number of descriptor clusters;
applying a second clustering process to the number of descriptor clusters to determine a descriptor cluster center for each of the number of descriptor clusters;
generating descriptor cluster data characterizing a similarity between the plurality of descriptors and the descriptor cluster centers; and
storing the descriptor cluster data in a data repository.

24. The non-transitory, machine-readable storage medium of clause 23, wherein the instructions, when executed by the at least one processor, cause the at least one processor to perform operations that include generating the descriptor cluster data to include a plurality of values characterizing the similarity between the plurality of descriptors and the descriptor cluster centers, wherein each of the plurality of values characterizes the similarity between one of the plurality of descriptors and one of the descriptor cluster centers.

25. The non-transitory, machine-readable storage medium of clause 24, wherein each of the plurality of values identifies a probability that one of the plurality of descriptors belongs to one of the descriptor cluster centers.

26. The non-transitory, machine-readable storage medium of any of clauses 23-25, wherein the instructions, when executed by the at least one processor, cause the at least one processor to perform operations that include:
receiving, from a remote device, location data characterizing the geographic location; and
in response to receiving the location data, transmitting the descriptor cluster data to the remote device.

27. The non-transitory, machine-readable storage medium of clause 26, wherein the instructions, when executed by the at least one processor, cause the at least one processor to perform operations that include, comprising:
receiving descriptor matching data from the remote device, the descriptor matching data characterizing a matching result of the descriptor cluster data; and
adjusting the descriptor cluster data in the data repository based on the descriptor matching data.

28. The non-transitory, machine-readable storage medium of clause 27, wherein the descriptor matching data comprises a number of descriptor matches for at least one of the descriptor cluster centers, and wherein the instructions, when executed by the at least one processor, cause the at least one processor to perform operations that include:
determining a matching performance of the at least one of the descriptor cluster centers based on the number of descriptor matches; and
adjusting the descriptor cluster data based on the matching performance.

29. The non-transitory, machine-readable storage medium of any of clauses 27-28, wherein the instructions, when executed by the at least one processor, cause the at least one processor to perform operations that include:
weighting the descriptor cluster centers based on the descriptor matching data;
applying the first clustering process to the plurality of descriptors and the weighted descriptor cluster centers to determine a second number of descriptor clusters;
applying the second clustering process to the second number of descriptor clusters to determine a second descriptor cluster center for each of the second number of descriptor clusters; and
adjusting the descriptor cluster data to characterize a similarity between the plurality of descriptors and the second number of descriptor cluster centers.

30. The non-transitory, machine-readable storage medium of any of clauses 23-29, wherein the instructions, when executed by the at least one processor, cause the at least one processor to perform operations that include:
receiving from a plurality of remote devices descriptor matching data for the geographic location, the descriptor matching data characterizing a matching result of at least one descriptor cluster center to a number of features, and a statistical measure based on a number of features successfully matched to the at least one descriptor cluster center;
determining a matching performance for the geographic location based on the matching result of the at least one descriptor cluster center to the number of features, and the statistical measure; and
adjusting the descriptor cluster data based on the matching performance.

31. The non-transitory, machine-readable storage medium of any of clause 30, wherein the instructions, when executed by the at least one processor, cause the at least one processor to perform operations that include:
adjusting a weight of the at least one descriptor cluster center based on the matching performance;
weighting the at least one descriptor cluster center based on the weight;
applying the first clustering process to the plurality of descriptors and the descriptor cluster centers to determine a second number of descriptor clusters, the descriptor cluster centers comprising the weighted at least one descriptor cluster center;
applying the second clustering process to the second number of descriptor clusters to determine a second descriptor cluster center for each of the second number of descriptor clusters; and
adjusting the descriptor cluster data to characterize a similarity between the plurality of descriptors and the second number of descriptor cluster centers.

32. The non-transitory, machine-readable storage medium of any of clause 23-31, wherein the instructions, when executed by the at least one processor, cause the at least one processor to perform operations that include establishing the first clustering process as a k-means++ clustering process.

33. The non-transitory, machine-readable storage medium of any of clauses 23-32, wherein the instructions, when executed by the at least one processor, cause the at least one processor to perform operations that include establishing the second clustering process as a fuzzy c-means clustering process.

34. A device comprising:
a means for applying a first clustering process to a plurality of descriptors associated with a geographical location to determine a number of descriptor clusters;
a means for applying a second clustering process to the number of descriptor clusters to determine a descriptor cluster center for each of the number of descriptor clusters;
a means for generating descriptor cluster data characterizing a similarity between the plurality of descriptors and the descriptor cluster centers; and
a means for storing the descriptor cluster data in a data repository.

35. The device of clause 34, comprising a means for generating the descriptor cluster data to include a plurality of values characterizing the similarity between the plurality of descriptors and the descriptor cluster centers, wherein each of the plurality of values characterizes the similarity between one of the plurality of descriptors and one of the descriptor cluster centers.

36. The device of clause 35, wherein each of the plurality of values identifies a probability that one of the plurality of descriptors belongs to one of the descriptor cluster centers.

37. The device of any of clauses 34-36, comprising:
a means for receiving, from a remote device, location data characterizing the geographic location; and
a means for, in response to receiving the location data, transmitting the descriptor cluster data to the remote device.

38. The device of clause 37, comprising:
a means for receiving descriptor matching data from the remote device, the descriptor matching data characterizing a matching result of the descriptor cluster data; and
a means for adjusting the descriptor cluster data in the data repository based on the descriptor matching data.

39. The device of clause 38, wherein the descriptor matching data comprises a number of descriptor matches for at least one of the descriptor cluster centers, the method comprising:
a means for determining a matching performance of the at least one of the descriptor cluster centers based on the number of descriptor matches; and
a means for adjusting the descriptor cluster data based on the matching performance.

40. The device of any of clauses 38-39, comprising:
a means for weighting the descriptor cluster centers based on the descriptor matching data;
a means for applying the first clustering process to the plurality of descriptors and the weighted descriptor cluster centers to determine a second number of descriptor clusters;
a means for applying the second clustering process to the second number of descriptor clusters to determine a second descriptor cluster center for each of the second number of descriptor clusters; and
a means for adjusting the descriptor cluster data to characterize a similarity between the plurality of descriptors and the second number of descriptor cluster centers.

41. The device of any of clauses 34-40, comprising:
a means for receiving from a plurality of remote devices descriptor matching data for the geographic location, the descriptor matching data characterizing a matching result of at least one descriptor cluster center to a number of features, and a statistical measure based on a number of features successfully matched to the at least one descriptor cluster center;
a means for determining a matching performance for the geographic location based on the matching result of the at least one descriptor cluster center to the number of features, and the statistical measure; and
a means for adjusting the descriptor cluster data based on the matching performance.

42. The device of clause 41, comprising:
a means for adjusting a weight of the at least one descriptor cluster center based on the matching performance;
a means for weighting the at least one descriptor cluster center based on the weight;
a means for applying the first clustering process to the plurality of descriptors and the descriptor cluster centers to determine a second number of descriptor clusters, the descriptor cluster centers comprising the weighted at least one descriptor cluster center;
a means for applying the second clustering process to the second number of descriptor clusters to determine a second descriptor cluster center for each of the second number of descriptor clusters; and
a means for adjusting the descriptor cluster data to characterize a similarity between the plurality of descriptors and the second number of descriptor cluster centers.

43. The device of any of clauses 34-42, comprising a means for establishing the first clustering process as a k-means++ clustering process.

44. The device of any of clauses 34-43, comprising a means for establishing the second clustering process as a fuzzy c-means clustering process.

45. An apparatus comprising:
a non-transitory, machine-readable storage medium storing instructions; and
at least one processor coupled to the non-transitory, machine-readable storage medium, the at least one processor being configured to execute the instructions to:
   generate an image descriptor based on an image;
   receive descriptor cluster data, wherein the descriptor cluster data characterizes a similarity between a plurality of descriptors and a plurality of descriptor cluster centers;
   determine at least one of the plurality of descriptor cluster centers based on the image descriptor and the descriptor cluster data; and
   determine a position based on the at least one of the plurality of descriptor cluster centers.

46. The apparatus of clause 45, wherein the at least one processor is further configured to execute the instructions to:
compute a distance between the image descriptor and each of the plurality of descriptor cluster centers; and
determine the at least one of the plurality of descriptor cluster centers based on the distances.

47. The apparatus of clause 46, wherein the descriptor cluster data comprises a plurality of values, wherein each of the plurality of values identifies a probability that one of the plurality of descriptors belongs to one of the descriptor cluster centers, and wherein the at least one processor is further configured to execute the instructions to determine the at least one of the plurality of descriptor cluster centers based on the plurality of values.

48. The apparatus of any of clauses 45-47 comprising at least one camera, wherein the at least one camera is configured to capture the image.

49. The apparatus of any of clauses 45-48 comprising a display, wherein the at least one processor is further configured to execute the instructions to provide to the display an extended reality image that includes the object.

50. A method by at least one processor, the method comprising:
generating an image descriptor based on an image;
receiving descriptor cluster data, wherein the descriptor cluster data characterizes a similarity between a plurality of descriptors and a plurality of descriptor cluster centers;
determining at least one of the plurality of descriptor cluster centers based on the image descriptor and the descriptor cluster data; and
determining a position based on the at least one of the plurality of descriptor cluster centers.

51. The method of clause 50, comprising:
computing a distance between the image descriptor and each of the plurality of descriptor cluster centers; and
determining the at least one of the plurality of descriptor cluster centers based on the distances.

52. The method of clause 51, wherein the descriptor cluster data comprises a plurality of values, wherein each of the plurality of values identifies a probability that one of the plurality of descriptors belongs to one of the descriptor cluster centers, the method comprising determining the at least one of the plurality of descriptor cluster centers based on the plurality of values.

53. The method of any of clauses 50-52, comprising causing a camera to capture the at least one image.

54. The method of any of clauses 50-53, comprising providing to a display an extended reality image that includes the object.

55. A non-transitory, machine-readable storage medium storing instructions that, when executed by at least one processor, causes the at least one processor to perform operations that include:
generating an image descriptor based on an image;
receiving descriptor cluster data, wherein the descriptor cluster data characterizes a similarity between a plurality of descriptors and a plurality of descriptor cluster centers;
determining at least one of the plurality of descriptor cluster centers based on the image descriptor and the descriptor cluster data; and
determining a position based on the at least one of the plurality of descriptor cluster centers.

56. The non-transitory, machine-readable storage medium of clause 55, wherein the instructions, when executed by the at least one processor, cause the at least one processor to perform operations that include:
computing a distance between the image descriptor and each of the plurality of descriptor cluster centers; and
determining the at least one of the plurality of descriptor cluster centers based on the distances.

57. The non-transitory, machine-readable storage medium of clause 56, wherein the descriptor cluster data comprises a plurality of values, wherein each of the plurality of values identifies a probability that one of the plurality of descriptors belongs to one of the descriptor cluster centers, and wherein the instructions, when executed by the at least one processor, cause the at least one processor to perform operations that include determining the at least one of the plurality of descriptor cluster centers based on the plurality of values.

58. The non-transitory, machine-readable storage medium of any of clauses 55-57, wherein the instructions, when executed by the at least one processor, cause the at least one processor to perform operations that include causing a camera to capture the at least one image.

59. The non-transitory, machine-readable storage medium of any of clauses 55-58, wherein the instructions, when executed by the at least one processor, cause the at least one processor to perform operations that include providing to a display an extended reality image that includes the object.

60. A device comprising:
a means for generating an image descriptor based on an image; a means for receiving descriptor cluster data, wherein the descriptor cluster data characterizes a similarity between a plurality of descriptors and a plurality of descriptor cluster centers;
a means for determining at least one of the plurality of descriptor cluster centers based on the image descriptor and the descriptor cluster data; and
a means for determining a position based on the at least one of the plurality of descriptor cluster centers.

61. The device of clause 60, comprising:
a means for computing a distance between the image descriptor and each of the plurality of descriptor cluster centers; and
a means for determining the at least one of the plurality of descriptor cluster centers based on the distances.

62. The device of clause 61, wherein the descriptor cluster data comprises a plurality of values, wherein each of the plurality of values identifies a probability that one of the plurality of descriptors belongs to one of the descriptor cluster centers, the device comprising a means for determining the at least one of the plurality of descriptor cluster centers based on the plurality of values.

63. The device of any of clauses 60-62, comprising a means for causing a camera to capture the at least one image.

64. The device of any of clauses 60-63, comprising a means for providing to a display an extended reality image that includes the object.

Although the methods described above are with reference to the illustrated flowcharts, many other ways of performing the acts associated with the methods may be used. For example, the order of some operations may be changed, and some embodiments may omit one or more of the operations described and/or include additional operations.

In addition, the methods and system described herein may be at least partially embodied in the form of computer-implemented processes and apparatus for practicing those processes. The disclosed methods may also be at least partially embodied in the form of tangible, non-transitory machine-readable storage media encoded with computer program code. For example, the methods may be embodied in hardware, in executable instructions executed by a processor (e.g., software), or a combination of the two. The media may include, for example, RAMs, ROMs, CD-ROMs, DVD-ROMs, BD-ROMs, hard disk drives, flash memories, or any other non-transitory machine-readable storage medium. When the computer program code is loaded into and executed by a computer, the computer becomes an apparatus for practicing the method. The methods may also be at least partially embodied in the form of a computer into which computer program code is loaded or executed, such that, the computer becomes a special purpose computer for practicing the methods. When implemented on a general-purpose processor, computer program code segments configure the processor to create specific logic circuits. The methods may alternatively be at least partially embodied in application specific integrated circuits for performing the methods.

The subject matter has been described in terms of exemplary embodiments. Because they are only examples, the claimed inventions are not limited to these embodiments. Changes and modifications may be made without departing the spirit of the claimed subject matter. It is intended that the claims cover such changes and modifications.

We claim:

1. An apparatus comprising:
a non-transitory, machine-readable storage medium storing instructions; and
at least one processor coupled to the non-transitory, machine-readable storage medium, the at least one processor being configured to execute the instructions to:
apply a first clustering process to a plurality of descriptors associated with a geographical location to determine a number of descriptor clusters;
apply a second clustering process to the number of descriptor clusters to determine a descriptor cluster center for each of the number of descriptor clusters;
generate descriptor cluster data characterizing a similarity between the plurality of descriptors and the descriptor cluster centers; and
store the descriptor cluster data in a data repository.

2. The apparatus of claim 1, wherein the at least one processor is further configured to execute the instructions to generate the descriptor cluster data to include a plurality of values characterizing the similarity between the plurality of descriptors and the descriptor cluster centers, wherein each of the plurality of values characterizes the similarity between one of the plurality of descriptors and one of the descriptor cluster centers.

3. The apparatus of claim 2, wherein each of the plurality of values identifies a probability that one of the plurality of descriptors belongs to one of the descriptor cluster centers.

4. The apparatus of claim 1, wherein the at least one processor is further configured to execute the instructions to:
receive, from a remote device, location data characterizing the geographic location; and
in response to receiving the location data, transmit the descriptor cluster data to the remote device.

5. The apparatus of claim 4, wherein the at least one processor is further configured to execute the instructions to:
receive descriptor matching data from the remote device, the descriptor matching data characterizing a matching result of the descriptor cluster data; and
adjust the descriptor cluster data in the data repository based on the descriptor matching data.

6. The apparatus of claim 5, wherein the descriptor matching data comprises a number of descriptor matches for at least one of the descriptor cluster centers, wherein at least one processor is configured to execute the instructions to:
determine a matching performance of the at least one of the descriptor cluster centers based on the number of descriptor matches; and
adjust the descriptor cluster data based on the matching performance.

7. The apparatus of claim 5, wherein the at least one processor is further configured to execute the instructions to:
weight the descriptor cluster centers based on the descriptor matching data;
apply the first clustering process to the plurality of descriptors and the weighted descriptor cluster centers to determine a second number of descriptor clusters;
apply the second clustering process to the second number of descriptor clusters to determine a second descriptor cluster center for each of the second number of descriptor clusters; and
adjust the descriptor cluster data to characterize a similarity between the plurality of descriptors and the second number of descriptor cluster centers.

8. The apparatus of claim 1, wherein the at least one processor is configured to execute the instructions to:
receive from a plurality of remote devices descriptor matching data for the geographic location, the descriptor matching data characterizing a matching result of at least one descriptor cluster center to a number of features, and a statistical measure based on a number of features successfully matched to the at least one descriptor cluster center;
determine a matching performance for the geographic location based on the matching result of the at least one descriptor cluster center to the number of features, and the statistical measure; and
adjust the descriptor cluster data based on the matching performance.

9. The apparatus of claim 8, wherein the at least one processor is configured to execute the instructions to:
adjust a weight of the at least one descriptor cluster center based on the matching performance;
weight the at least one descriptor cluster center based on the weight;
apply the first clustering process to the plurality of descriptors and the descriptor cluster centers to determine a second number of descriptor clusters, the descriptor cluster centers comprising the weighted at least one descriptor cluster center;
apply the second clustering process to the second number of descriptor clusters to determine a second descriptor cluster center for each of the second number of descriptor clusters; and
adjust the descriptor cluster data to characterize a similarity between the plurality of descriptors and the second number of descriptor cluster centers.

10. A method by at least one processor, the method comprising:
applying a first clustering process to a plurality of descriptors associated with a geographical location to determine a number of descriptor clusters;
applying a second clustering process to the number of descriptor clusters to determine a descriptor cluster center for each of the number of descriptor clusters;
generating descriptor cluster data characterizing a similarity between the plurality of descriptors and the descriptor cluster centers; and
storing the descriptor cluster data in a data repository.

11. The method of claim 10, comprising generating the descriptor cluster data to include a plurality of values characterizing the similarity between the plurality of descriptors and the descriptor cluster centers, wherein each of the plurality of values characterizes the similarity between one of the plurality of descriptors and one of the descriptor cluster centers.

12. The method of claim 10, comprising:
receiving, from a remote device, location data characterizing the geographic location; and
in response to receiving the location data, transmitting the descriptor cluster data to the remote device.

13. The method of claim 12, comprising:
receiving descriptor matching data from the remote device, the descriptor matching data characterizing a matching result of the descriptor cluster data; and
adjusting the descriptor cluster data in the data repository based on the descriptor matching data.

14. The method of claim 13, comprising:
weighting the descriptor cluster centers based on the descriptor matching data;
applying the first clustering process to the plurality of descriptors and the weighted descriptor cluster centers to determine a second number of descriptor clusters;
applying the second clustering process to the second number of descriptor clusters to determine a second descriptor cluster center for each of the second number of descriptor clusters; and
adjusting the descriptor cluster data to characterize a similarity between the plurality of descriptors and the second number of descriptor cluster centers.

15. The method of claim 10, comprising:
receiving from a plurality of remote devices descriptor matching data for the geographic location, the descriptor matching data characterizing a matching result of at least one descriptor cluster center to a number of features, and a statistical measure based on a number of features successfully matched to the at least one descriptor cluster center;
determining a matching performance for the geographic location based on the matching result of the at least one descriptor cluster center to the number of features, and the statistical measure; and
adjusting the descriptor cluster data based on the matching performance.

16. An apparatus comprising:
a non-transitory, machine-readable storage medium storing instructions; and
at least one processor coupled to the non-transitory, machine-readable storage medium, the at least one processor being configured to execute the instructions to:
generate an image descriptor based on an image;
receive descriptor cluster data, wherein the descriptor cluster data characterizes a similarity between a plurality of descriptors and a plurality of descriptor cluster centers;
determine at least one of the plurality of descriptor cluster centers based on the image descriptor and the descriptor cluster data; and
determine a position based on the at least one of the plurality of descriptor cluster centers.

17. The apparatus of claim 16, wherein the at least one processor is further configured to execute the instructions to:
compute a distance between the image descriptor and each of the plurality of descriptor cluster centers; and
determine the at least one of the plurality of descriptor cluster centers based on the distances.

18. The apparatus of claim 17, wherein the descriptor cluster data comprises a plurality of values, wherein each of the plurality of values identifies a probability that one of the plurality of descriptors belongs to one of the descriptor cluster centers, and wherein the at least one processor is further configured to execute the instructions to determine the at least one of the plurality of descriptor cluster centers based on the plurality of values.

19. The apparatus of claim 16 comprising at least one camera, wherein the at least one camera is configured to capture the image.

20. The apparatus of claim 16 comprising a display, wherein the at least one processor is further configured to execute the instructions to provide to the display an extended reality image that includes the object.
